(19) United States
(12) Patent Application Publication
(10) Pub. No.: US 2026/0063185 A1
(43) Pub. Date: Mar. 5, 2026

(54) ENERGY ABSORPTION STRUCTURE

(71) Applicant: Toyota Motor Engineering & Manufacturing North America, Inc., Plano, TX (US)

(72) Inventors: Koray Benli, Ann Arbor, MI (US); Yuyang Song, Ann Arbor, MI (US); Umesh N. Gandhi, Farmington Hills, MI (US); Shinnosuke Shimokawa, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/817,449

(22) Filed: Aug. 28, 2024

(51) Int. Cl. F16F 9/04

(52) U.S. Cl. CPC F16F 9/0418; F16F 2230/06; F16F 2230/08; F16F 2230/18; F16F 2234/06

(57) ABSTRACT

An energy absorption structure can include an inflatable body. The inflatable body can include a plurality of cells arranged in a Miura-Ori pattern. Each of the plurality of cells can include one or more fluid channels.

### FIELD

The subject matter described herein relates in general to energy absorption structures and, more particularly, to inflatable energy absorption structures.

### BACKGROUND

Some energy absorption structures are inflatable. Such structures can generally begin as a flat bladder, which transform into a non-flat shape upon inflation with a fluid, such as air. Some inflatable energy absorption structures can be made of permanently creased rigid sheet materials (e.g., polyethylene terephthalate (PET), aramid, aluminum) to form a column-like rigid structures capable of collapsing in a predetermined way under external load.

### SUMMARY

In one respect, the present disclosure is directed to an energy absorption structure. The energy absorption structure can include an inflatable body. The inflatable body can include a plurality of cells arranged in a Miura-Ori pattern. Each of the plurality of cells can include one or more fluid channels.

In another respect, the present disclosure is directed to a system. The system can include an energy absorption structure. The energy absorption structure can have an inflatable body. The inflatable body can include a plurality of cells arranged in a Miura-Ori pattern. Each of the plurality of cells can include one or more fluid channels. The system can include one or more processors operatively connected to cause the energy absorption structure to be inflated.

### BRIEF DESCRIPTION OF THE DRAWINGS

FIG. 1 is a first example of an energy absorption structure including a single cell, showing a non-inflated configuration.

FIG. 2 is the energy absorption structure of FIG. 1, showing an inflated configuration.

FIG. 3 is a second example of an energy absorption structure including a plurality of cells, showing a non-inflated configuration.

FIG. 4 is the energy absorption structure of FIG. 3, showing one stage of an inflated configuration.

FIG. 5 is the energy absorption structure of FIG. 3, showing another stage of the inflated configuration.

FIG. 6 is a third example of an energy absorption structure including a plurality of cells arranged in a Miura-Ori pattern, showing a non-inflated configuration.

FIG. 7 is the energy absorption structure of FIG. 6, showing one stage of an inflated configuration.

FIG. 8 is the energy absorption structure of FIG. 6, showing another stage of the inflated configuration.

FIG. 9 is a fourth example of an energy absorption structure including a plurality of cells arranged in a Miura-Ori pattern, showing a non-inflated configuration.

FIG. 10 is the energy absorption structure of FIG. 9, showing an inflated configuration.

FIG. 11 is the energy absorption structure of FIG. 9, showing a configuration in which opposing sides are operatively connected to each other and showing a non-inflated configuration.

FIG. 12 is the energy absorption structure of FIG. 11, showing an inflated configuration.

FIG. 13 is the energy absorption structure of FIG. 12, showing the energy absorption structure in a vertical orientation.

FIG. 14 is the energy absorption structure of FIG. 13, showing the energy absorption structure being compressed.

FIG. 15 is the energy absorption structure of FIG. 13, showing the energy absorption structure in a full compressed configuration.

FIG. 16 is an example of a system for an energy absorption structure.

FIG. 17 is an example of a method for an energy absorption structure.

### DETAILED DESCRIPTION

The existing energy-absorbing rigid structures need to be in their permanently deployed states in order to function, which limits their use for the space-saving design applications. Moreover, since these structures plastically deform to absorb energy, they need to be replaced after each use. These and/or other issues that inflatable energy absorption structures may experience can be addressed by alternative energy absorption structures.

Accordingly, arrangements described herein are directed to an energy absorption structure. The energy absorption structure can include an inflatable body. The inflatable body can include a plurality of cells arranged in a Miura-Ori pattern. Each of the plurality of cells can include one or more fluid channels.

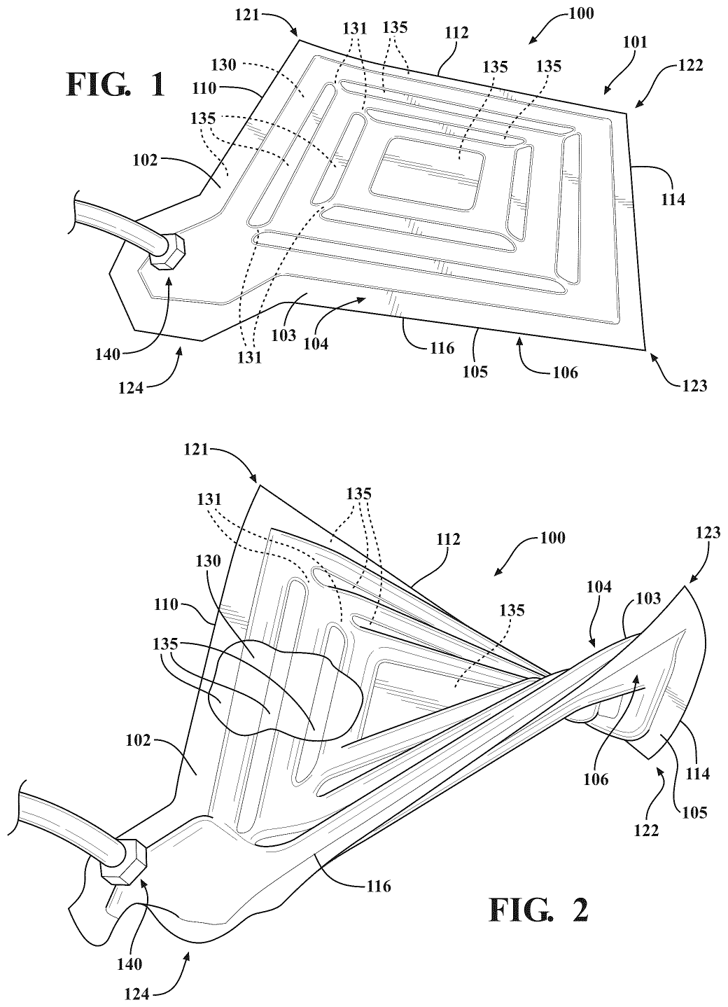

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-17, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

Referring to FIGS. 1-2, a first example of an energy absorption structure 100 is shown. In this example, the energy absorption structure 100 includes a body 102. The body 102 can be an inflatable body. The body 102 can be single cell 101.

The energy absorption structure 100 can include a first major surface 104 and a second major surface 106. The first major surface 104 and the second major surface 106 can be opposite each other. The first major surface 104 and the second major surface 106 can be substantially planar. The first major surface 104 and the second major surface 106 can be substantially parallel to each other. In some arrangements, the energy absorption structure 100 can include a first layer 103 and a second layer 105. In such case, the first layer 103 can define the first major surface 104, and the second layer 105 can define the second major surface 106.

The energy absorption structure 100 can include a plurality of sides. In the arrangement shown in FIGS. 1-2, the energy absorption structure 100 can have a first side 110, a second side 112, a third side 114, and a fourth side 116. The first side 110 and the third side 114 can be substantially parallel to each other. The second side 112 and the fourth side 116 can be substantially parallel to each other. The first side 110, the second side 112, the third side 114, and the fourth side 116 can be sealed.

There can be any suitable relationship between the first side 110 and/or the third side 114 relative to the second side 112 and/or the fourth side 116. In some arrangements, the first side 110 and/or the third side 114 can be substantially perpendicular to the second side 112 and/or the fourth side 116. In other arrangements, the first side 110 and/or the third side 114 can be non-perpendicular to the second side 112 and/or the fourth side 116.

In some arrangements, the first side 110, the second side 112, the third side 114, and the fourth side 116 can be substantially straight or substantially linear. However, in some arrangements, at least one of the first side 110, the second side 112, the third side 114, and the fourth side 116 can be non-straight or non-linear.

The energy absorption structure 100 can include a plurality of corners. In the arrangement shown in FIGS. 1-2, the energy absorption structure 100 can have a first corner 121, a second corner 122, a third corner 123, and a fourth corner 124.

The body 102 can have any suitable overall shape when non-activated (e.g., FIG. 1). In one or more arrangements, the body 102 can have a substantially rectangular shape. In one or more arrangements, the body 102 can have a substantially parallelogram shape. More particularly, the body 102 can have a substantially non-rectangular parallelogram shape. However, it will be appreciated that the body 102 is not limited to being a parallelogram shape.

The body 102 can be made of any suitable material. For instance, in some arrangements, the body 102 can be made of a flexible, pliable, stretchable, and/or compliant material. The body 102 can be made of a durable material. In one or more arrangements, the body 102 can be made of fabric. In some arrangements, the body 102 can be made of a material that is fluidly impermeable. More particularly, the body 102 can be made of a material that is air impermeable. It should be noted that FIG. 1 shows a non-inflated condition of the body 102. In one or more arrangements, the body 102 can be made of thermoplastic polyurethane (TPU) or nylon.

The fluid channel(s) 130 can be arranged in any suitable manner. In one or more arrangements, the fluid channel(s) 130 can be arranged in a substantially concentric pattern or a nested pattern. In one or more arrangements, the fluid channel(s) 130 can be substantially rectangular shaped. In such case, the fluid channel(s) 130 can define a plurality of substantially rectangular channels that are substantially concentric or nested.

The body 102 can include one or more fluid channels 130. The fluid channel(s) 130 can all be fluidly connected with each other. The fluid channel(s) 130 can be interconnected, such as by a plurality of connecting channels 131. In the example shown, the connecting channels 131 can be located at or near the corners of the fluid channel(s) 130. Thus, the body 102 can be said to have a single fluid channel 130.

The fluid channel(s) 130 can be formed in any suitable manner. For instance, in some arrangements, the fluid channel(s) 130 can be partially formed by a first layer 103 and a second layer 105. The first layer 103 can define the first major surface 104, and the second layer 105 can define the second major surface 106. For instance, the first major surface 104 and the second major surface 106 can be joined together in certain areas, such as by one or more adhesives, one or more fasteners, one or more bonds, one or more fasteners, one or more forms of mechanical engagement, or any combination thereof.

In some arrangements, the fluid channels(s) 130 can further be defined by a plurality of walls or barriers 135 located within the body 102. The barriers 135 can be located between the first layer 103 and the second layer 105. In one or more arrangements, the barriers 135 can define an intermediate layer or masking layer between the first layer 103 and the second layer 105.

The barriers 135 can be separate structures located between the first layer 103 and the second layer 105. In such case, the barriers 135 can be operatively connected to the first layer 103 and/or the second layer 105. In some instances, the barriers 135 can be operatively connected to the first layer 103 and/or the second layer 105, such as by one or more adhesives, one or more fasteners, one or more bonds, one or more fasteners, one or more forms of mechanical engagement, or any combination thereof.

The energy absorption structure 100 can include an inlet 140. The inlet 140 can be in fluid communication with the fluid channel(s) 130. One or more fluids can be supplied to the fluid channel(s) 130 by the inlet 140. In some arrangements, the inlet 140 can be a single inlet. The inlet 140 can include one or more devices, structures, components, couplings, hoses, ducts, conduits, or fasteners to facilitate fluid connection to an inflation source.

FIG. 1 shows the energy absorption structure 100 in a non-activated configuration. In the non-activated configuration, the energy absorption structure 100 can be substantially flat or substantially two dimensional.

The energy absorption structure 100 can morph into an activated configuration by inflating the energy absorption structure 100. Any suitable fluid can be used to inflate the body 102. For instance, the body 102 can be inflated by air, a shear thickening fluid (STF), other suitable fluid, or any combination thereof. In some arrangements the STF can be supplied to local areas of the fluid channel(s) 130.

FIG. 2 shows the energy absorption structure 100 in the activated configuration. In the activated configuration, the body 102 can deform in a plurality of directions. Thus, the energy absorption structure 100 can go from being a substantially two-dimensional or a substantially flat shape to a three-dimensional shape or a non-flat shape. It will be appreciated that the activated configuration of the energy absorption structure 100 can be defined by the body 102, the fluid channel(s) 130, and/or the barriers 135.

The deformation can be defined in part by the layout of the fluid channel(s) 130 and/or the barrier(s) 135 within the energy absorption structure 100. In the example shown in FIG. 2, the energy absorption structure 100 can fold generally diagonally in a direction from the second corner 122 to the fourth corner 124. The first corner 121 and the third corner 123 can turn upward, in the orientation shown in FIG. 2. The first corner 121 and the third corner 123 can come closer together. The second corner 122 and the fourth corner 124 can turn downwardly.

The energy absorption structure 100 can be configured to maintain the activated configuration. The energy absorption structure 100 can be configured to substantially return to the non-activated configuration at any suitable time. For instance, a vacuum can be used to draw the fluid(s) out of the fluid channel(s) 130. Thus, the energy absorption structure 100 can return to a flat condition.

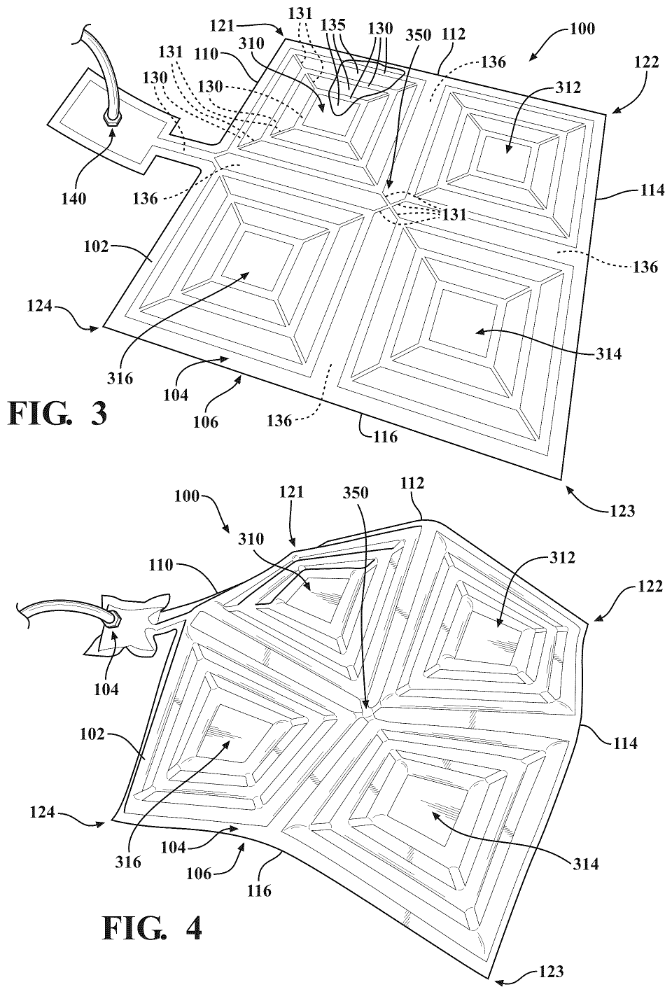

FIG. 3 shows a second example of an energy absorption structure 100. The energy absorption structure 100 can include a body 102. For convenience, reference numbers from FIGS. 1-2 will be repeated throughout the drawings for like structures.

Thus, the energy absorption structure 100 can include a first major surface 104 and a second major surface 106. The energy absorption structure 100 can have a first side 110, a second side 112, a third side 114, and a fourth side 116. The energy absorption structure 100 can have a first corner 121, a second corner 122, a third corner 123, and a fourth corner 124. The above descriptions of these aspects of the energy absorption structure 100 made in connection with FIG. 1 apply equally here.

The body 102 can include a plurality of cells. In this example, the energy absorption structure 100 can be made of four cells: a first cell 310, a second cell 312, a third cell 314, and a fourth cell 316. The energy absorption structure 100 can have a central region 350.

The above description of the cell 101 in FIG. 1 applies to each of the plurality of cells 310, 312, 314, 316 in FIG. 4. In some arrangements, the plurality of cells 310, 312, 314, 316 can be substantially identical to each other. In some arrangements, one or more of the plurality of cells 310, 312, 314, 316 can be different from the other cells in one or more respects.

In this example, the first cell 310, the second cell 312, the third cell 314, and the fourth cell 316 can be substantially rectangular or substantially square. Thus, the overall shape of the energy absorption structure 100 can be substantially rectangular or substantially square. The first side 110 can be substantially parallel to the third side 114, and the second side 112 can be substantially parallel to the fourth side 116. The first side 110 can be substantially perpendicular to the second side 112 and the fourth side 116. The third side 114 can be substantially perpendicular to the second side 112 and the fourth side 116. The first corner 121, the second corner 122, the third corner 123, and the fourth corner 124 can form substantially right angles.

The body 102 can include one or more fluid channels 130 and a plurality of barriers 135. The fluid channel(s) 130 can all be fluidly connected with each other. The fluid channel(s) 130 can be interconnected, such as by a plurality of connecting channels 131. The above discussion of the fluid channel(s) 130 and the connecting channels 131 made in connection with FIG. 1 applies to each of the plurality of cells 310, 312, 314, 316 in FIG. 4.

The plurality of cells 310, 312, 314, 316 can be separated from each other by the barriers 135, which, for convenience will be referred to as separation barriers 136. For example, the first cell 310 and the second cell 312 can be separated by a separation barrier 136. The first cell 310 and the fourth cell 316 can be separated by a separation barrier 136. The second cell 312 and the third cell 314 can be separated by a separation barrier 136. The third cell 314 and the fourth cell 316 can be separated by a separation barrier 136. The separation barriers 136 between the plurality of cells 310, 312, 314, 316 can come together in the central region 350, and there can be connecting channels 131 between the separation barriers 136 in the central region 350. Thus, fluid communication between the plurality of cells 310, 312, 314, 316 can be permitted.

The energy absorption structure 100 can include an inlet 140. The inlet 140 can be in fluid communication with the fluid channel(s) 130. One or more fluids can be supplied to the fluid channel(s) 130 by the inlet 140. In some arrangements, the inlet 140 is a single inlet. The inlet 140 can include one or more devices, structures, components, or fasteners to facilitate fluid connection to an inflation source.

FIG. 3 shows the energy absorption structure 100 in a non-activated configuration. In the non-activated configuration, the energy absorption structure 100 can be substantially flat. The energy absorption structure 100 can be considered to be substantially flat or substantially two-dimensional in the non-activated configuration.

The energy absorption structure 100 can morph into an activated configuration by inflating the energy absorption structure 100. Any suitable fluid can be used to inflate the body 102. For instance, the body 102 can be inflated by air, a shear thickening fluid (STF), other suitable fluid, or any combination thereof. In some arrangements the STF can be supplied to local areas of the fluid channel(s) 130.

FIG. 4 showing one stage of an activated or inflated configuration of the energy absorption structure 100. In the activated configuration, the body 102 can deform in a plurality of directions. Thus, the energy absorption structure 100 can go from being a substantially two-dimensional or a substantially flat shape to a three-dimensional shape or a non-flat shape. It will be appreciated that the activated configuration of the energy absorption structure 100 can be defined—by the body 102, the fluid channel(s) 130, the barriers 135, and/or the separation barriers 136.

The deformation can be defined in part by the layout of the fluid channel(s) 130, the barrier(s) 135, the separation barrier(s) 136, and/or the cells 310, 312, 314, 316. FIG. 4 can show an intermediate stage of inflation of the energy absorption structure 100. In this arrangements, the first corner 121, the second corner 122, the third corner 123, and the fourth corner 124 can fold downwardly in the orientation shown in FIG. 4. The central region 350 can move downwardly while central portions of the first side 110, the second side 112, the third side 114, and the fourth side 116 can move upwardly, as shown in FIG. 4. In some arrangements, one or more of the plurality of cells 310, 312, 314, 316 can begin to fold diagonally across its middle.

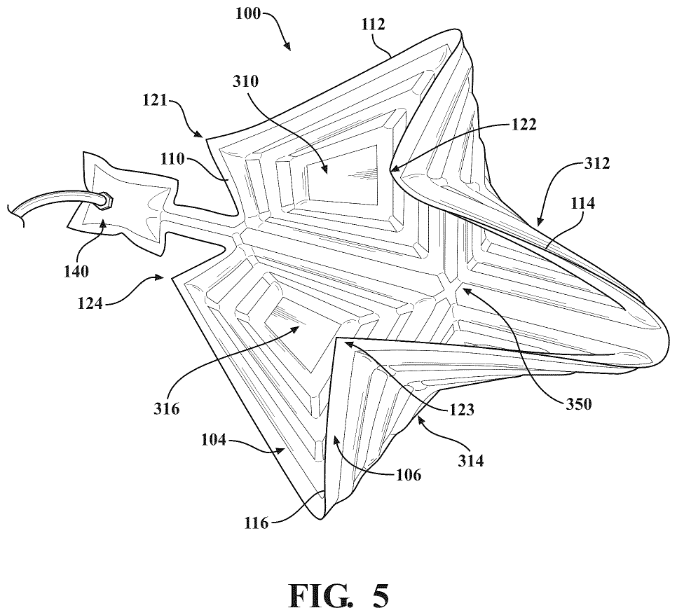

The inflation can continue to reach a subsequent stage of inflation of the energy absorption structure 100. An example of such subsequent stage is shown in FIG. 5. Here the first corner 121, the second corner 122, the third corner 123, and the fourth corner 124 can turn upwardly and inwardly toward the central region 350 of the energy absorption structure 100. A middle portion of the second side 112 and the fourth side 116 can fold inwardly toward each other. The resulting geometry of the energy absorption structure 100 can be complex.

The energy absorption structure 100 can be configured to maintain the activated configuration. The energy absorption structure 100 can be configured to substantially return to the non-activated configuration at any suitable time. For instance, a vacuum can be used to draw the fluid(s) out of the fluid channel(s) 130 and the connecting channels 131. Thus, the energy absorption structure 100 can return to a substantially flat condition.

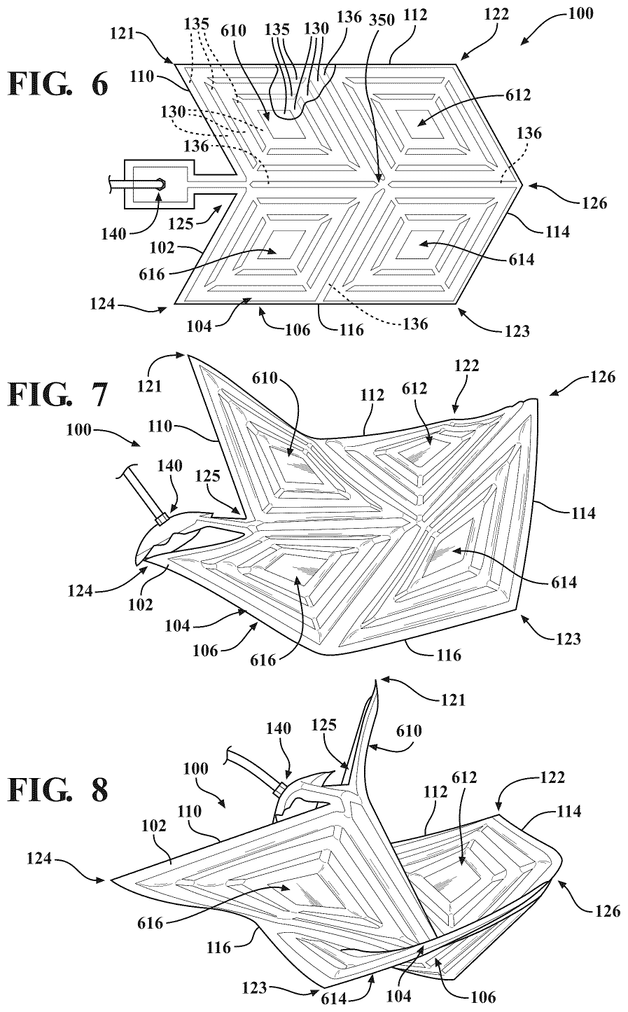

FIG. 6 shows a third example of an energy absorption structure 100. The energy absorption structure 100 can include a body 102. Again, for convenience, reference numbers from FIGS. 1-2 will be repeated throughout the drawings for like structures. Thus, the energy absorption structure 100 can include a first major surface 104 and a second major surface 106. The energy absorption structure 100 can have a first corner 121, a second corner 122, a third corner 123, a fourth corner 124, a fifth corner 125, and a sixth corner 126.

The body 102 can include a plurality of cells. In this example, the energy absorption structure 100 can be made of four cells: a first cell 610, a second cell 612, a third cell 614, and a fourth cell 616. The energy absorption structure 100 can have a central region 350.

The above description of the cell 101 in FIG. 1 applies to each of the plurality of cells 610, 612, 614, 616 in FIG. 6. In some arrangements, the plurality of cells 610, 612, 614, 616 can be substantially identical to each other. In some arrangements, one or more of the plurality of cells 610, 612, 614, 616 can be different from the other cells in one or more respects.

In this example, the cells 610, 612, 614, 616 can be substantially parallelogram shaped. More particularly, the cells 610, 612, 614, 616 can be non-rectangular parallelogram shaped.

The energy absorption structure 100 can include a first side 110, a second side 112, a third side 114, and a fourth side 116. The first side 110 and the third side 114 can be non-straight or non-linear. The first side 110 and the third side 114 can be non-parallel to each other. The second side 112 and the fourth side 116 can be substantially straight or substantially linear. The second side 112 and the fourth side 116 can be substantially parallel to each other. Overall, two substantially parallel sides and two non-parallel sides.

The plurality of cells 610, 612, 614, 616 can be arranged in a Miura-Ori pattern, which can be an origami-based pattern. Such a pattern can form a tessellation of the surface of the energy absorption structure 100 by parallelograms. In a first direction (e.g., the left-right direction in FIG. 6), the separation between the cells can be substantially linear. Each cell can form substantially a mirror image of its neighbor across the separation. In this example, the first cell 610 and the second cell 612 can be separated from the third cell 614 and the fourth cell 616 by a linear separation (e.g., the separation barriers 136 extending in the first direction). The first cell 610 can be substantially a mirror image of the fourth cell 616, and the second cell 612 can be substantially the mirror image of the third cell 614.

In a second direction (e.g., the up-down direction in FIG. 6), the separation between the cells can substantially zigzag. Each cell can be the translation of its neighbor across the separation. In this example, the first cell 610 and the fourth cell 616 can be separated from the second cell 612 and the third cell 614 by a zigzag separation (e.g., the separation barriers 136 extending in the second direction). The first cell 610 can be a translation of the second cell 612 across the separation, and the fourth cell 616 can be a translation of the third cell 614 across the separation.

The body 102 can include one or more fluid channels 130 and a plurality of barriers 135. The fluid channel(s) 130 can all be fluidly connected with each other. The fluid channel(s) 130 can be interconnected, such as by a plurality of connecting channels 131. The above discussion of the fluid channel(s) 130 and the connecting channels 131 made in connection with FIG. 1 applies to each of the plurality of cells 310, 312, 314, 316 in FIG. 4.

Further, the first cell 310 and the second cell 312 can be separated by a barrier 135. The first cell 310 and the fourth cell 316 can be separated by a barrier 135. The second cell 312 and the third cell 314 can be separated by a barrier 135. The third cell 314 and the fourth cell 316 can be separated by a barrier 135. The barriers 135 between the plurality of cells 310, 312, 314, 316 can come together in the central region 350, and there can be connecting channels 131 between the barriers 135 in the central region 350. Thus, fluid communication between the plurality of cells 310, 312, 314, 316 can be permitted.

The energy absorption structure 100 can include an inlet 140. The inlet 140 can be in fluid communication with the fluid channel(s) 130. One or more fluids can be supplied to the fluid channel(s) 130 by the inlet 140. In some arrangements, the inlet 140 is a single inlet. The inlet 140 can include one or more devices, structures, components, or fasteners to facilitate fluid connection to an inflation source.

FIG. 6 shows the energy absorption structure 100 in a non-activated configuration. In the non-activated configuration, the energy absorption structure 100 can be substantially flat. The energy absorption structure 100 can be considered to be substantially two-dimensional in the non-activated configuration.

The energy absorption structure 100 can morph into an activated configuration by inflating the energy absorption structure 100. Any suitable fluid can be used to inflate the body 102. For instance, the body 102 can be inflated by air, a shear thickening fluid (STF), other suitable fluid, or any combination thereof. In some arrangements the STF can be supplied to local areas of the fluid channel(s) 130.

FIG. 7 shows one stage of an inflated configuration of the energy absorption structure 100. The deformation can be defined in part by the layout of the fluid channel(s) 130, the barrier(s) 135, and/or the cells 610, 612, 614, 616. FIG. 7 shows an intermediate stage of inflation of the energy absorption structure 100. In this arrangement, the corners can fold in different directions. For instance, the first corners 121 can fold upwardly. The first cell 610 and the second cell 612 can move toward each other. central portion can move downwardly while portions of the sides move upwardly.

The inflation can continue to reach a subsequent stage of inflation of the energy absorption structure 100. An example of such subsequent stage is shown in FIG. 8. Here, the corners can turned upwardly and inwardly. The middle in two directions fold inwardly toward each other. The result geometry is complex.

The energy absorption structure 100 can be configured to maintain the activated configuration. The energy absorption structure 100 can be configured to substantially return to the non-activated configuration at any suitable time. For instance, a vacuum can be used to draw the fluid(s) out of the fluid channel(s) 130. Thus, the energy absorption structure 100 can return to a non-activate condition.

It will be appreciated that the deformation modes shown and described are merely one example. Any desired deformed can be achieved by the configuration of the energy absorption structure 100.

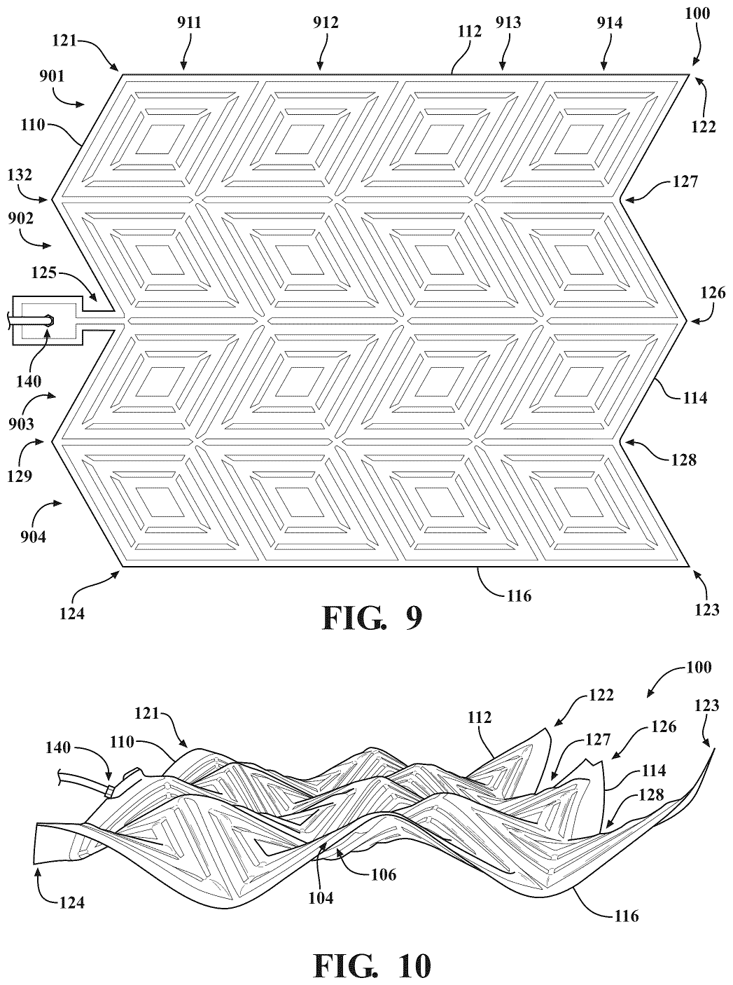

FIG. 9 shows a fourth example of an energy absorption structure 100. The energy absorption structure 100 can include a body 102. The body 102 can include a plurality of cells. In this example, the energy absorption structure 100 can be made of sixteen cells.

The above description of the cells in FIG. 6 applies to each of the plurality of cells in FIG. 9. In some arrangements, the plurality of cells can be substantially identical to each other. In some arrangements, one or more of the plurality of cells can be different from the other cells in one or more respects. The cells can be parallelogram shaped. More particularly, the cells can be non-rectangular parallelogram shaped. The plurality of cells can be arranged in a Miura-Ori pattern.

The plurality of cells can be arranged in a Miura-Ori pattern, which can be an origami-based pattern. Such a pattern can form a tessellation of the surface of the energy absorption structure 100 by parallelograms. In a first direction (e.g., the left-right direction in FIG. 6), the separation between the cells can be substantially linear. Each cell can form substantially a mirror image of its neighbor across the separation. In this example, a first row of cells 901 and a second row of cells 902 can be separated by a linear separation (e.g., the separation barriers 136 extending in the first direction). The first row of cells 901 can be substantially a mirror image of the second row of cells 902. Similar relationships are found between the second row of cells 902 and a third row of cells 903 as well as between the third row of cells 903 and a fourth row of cells 904.

In a second direction (e.g., the up-down direction in FIG. 6), the separation between the cells can substantially zigzag. Each cell can be the translation of its neighbor across the separation. In this example, a first column of cells 911 and a second column of cells 912 can be separated by a zigzag separation (e.g., the separation barriers 136 extending in the second direction). The first column of cells 911 can be a translation of the second column of cells 912 across the separation. Similar relationships are found between the second column of cells 912 and a third column of cells 913 as well as between the third column of cells 913 and a fourth column of cells 914.

The energy absorption structure 100 can have a plurality of corners 121, 122, 127, 126, 128, 123, 124, 129, 125, 132. The energy absorption structure 100 can include a first side 110, a second side 112, a third side 114, and a fourth side 116. The first side 110 and the third side 114 can be substantially linear or substantially straight. The first side 110 and the third side 114 can be substantially parallel to each other. The second side 112 and the fourth side 116 can be non-linear or non-straight. For example, the second side 112 and the fourth side 116 can have a zigzag shape. Thus, the second side 112 and the fourth side 116 can be non-parallel to each other.

The energy absorption structure 100 can include an inlet 140. The inlet 140 can be in fluid communication with the fluid channel(s) 130. One or more fluids can be supplied to the fluid channel(s) 130 by the inlet 140. In some arrangements, the inlet 140 is a single inlet. The inlet 140 can include one or more devices, structures, components, or fasteners to facilitate fluid connection to an inflation source.

FIG. 9 shows the energy absorption structure 100 in a non-activated configuration. In the non-activated configuration, the energy absorption structure 100 can be substantially flat.

The energy absorption structure 100 can morph into an activated configuration by inflating the energy absorption structure 100. Any suitable fluid can be used to inflate the body 102. For instance, the body 102 can be inflated by air, a shear thickening fluid (STF), other suitable fluid, or any combination thereof. In some arrangements the STF can be supplied to local areas of the fluid channel(s) 130.

The energy absorption structure 100 can be inflated to one or more stages of inflation. Thus, the energy absorption structure 100 can have a plurality of activated configurations. FIG. 10 shows one stage of an activated configuration. The configuration shown in FIG. 10 can represent an intermediate stage of inflation of the energy absorption structure 100 or a full inflation.

The energy absorption structure 100 can deform. The deformation can be defined in part by the layout of the fluid channel(s) 130, the barrier(s) 135, the separation barrier(s) 136, and/or the cells. In this arrangement, the corners can fold in different directions. For instance, the corners 121, 122, 126, 123, 124, 125 can fold upwardly. The corners 127, 128, 129, 132 can fold downwardly. The second side 112 and the fourth side 116 can become non-linear. In the example, shown the second side 112 and the fourth side 116 can form an undulating pattern.

The energy absorption structure 100 can be configured to maintain the activated configuration. The energy absorption structure 100 can be configured to substantially return to the non-activated configuration at any suitable time. For instance, a vacuum can be used to draw the fluid(s) out of the fluid channel(s) 130. Thus, the energy absorption structure 100 can return to a substantially flat, non-activated configuration.

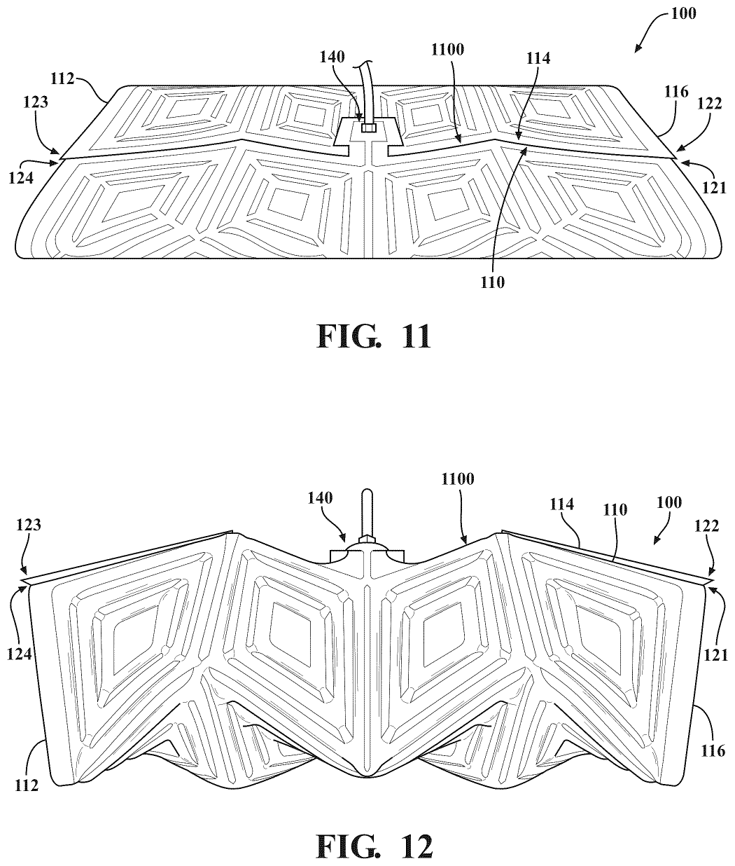

It will be appreciated that the deformation shown and described in connection with FIG. 11 are merely one example. A desired deformation can be achieved based on the configuration of the energy absorption structure 100.

FIGS. 11 and 12 show a variation of the arrangements in FIGS. 9-10. In this arrangement, opposing sides of the energy absorption structure 100 can be brought together and operatively connected to each other. In one or more arrangements, the non-parallel sides (e.g., the first side 110 and the third side 114) of the energy absorption structure 100 can be brought together. The first side 110 and the third side 114 can be operatively connected to each other, such as by one or more fasteners, one or more adhesives, one or more forms of mechanical engagement, or any combination thereof. In some arrangements, the first side 110 and the third side 114 can be operatively connected to each other by tape. The first side 110 and the third side 114 can substantially matingly engage each other to facilitate such connection. An interface 1100 can be formed at the junction between the first side 110 and the third side 114. In this example, the interface 1100 can extend in a zigzag, serpentine, or otherwise non-linear manner.

FIG. 11 shows the energy absorption structure 100 in a non-activated configuration (or non-inflated configuration). In the non-activated configuration, the energy absorption structure 100 can be substantially flat.

The energy absorption structure 100 can morph into an activated configuration by inflating the energy absorption structure 100. Any suitable fluid can be used to inflate the body 102. For instance, the body 102 can be inflated by air, a shear thickening fluid (STF), other suitable fluid, or any combination thereof. In some arrangements the STF can be supplied to local areas of the fluid channel(s) 130.

FIG. 12 shows an activated (or inflated) configuration of the energy absorption structure 100. When inflated, the energy absorption structure 100 can become more tubular in conformation. Thus, the body 102 can surround a space.

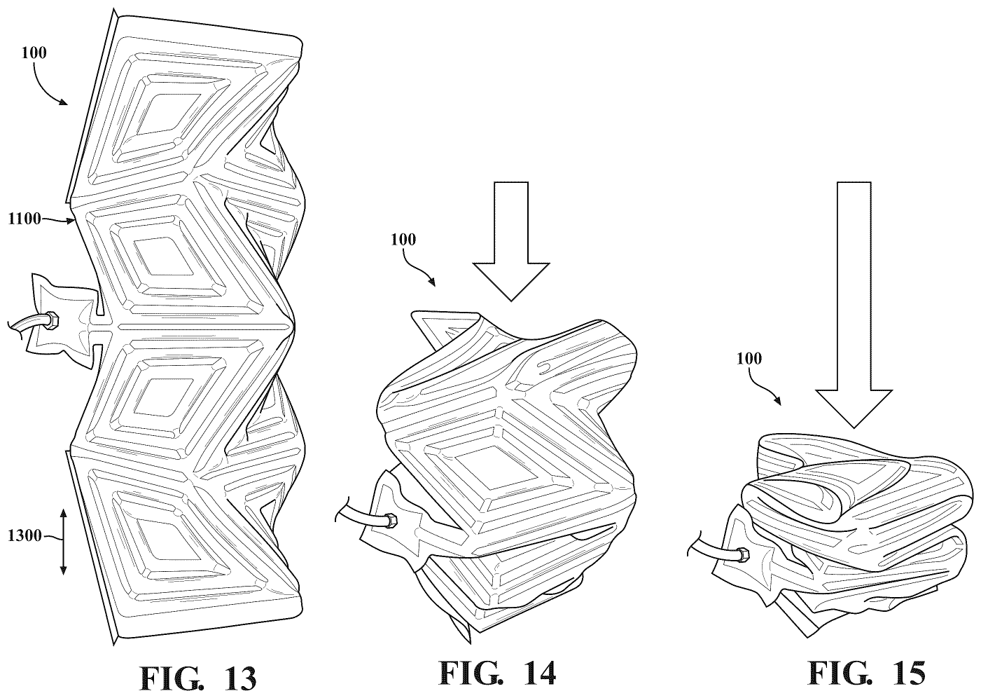

In this configuration, the energy absorption structure 100 can be oriented or posed in various ways. FIG. 13 shows an example in which the energy absorption structure 100 is arranged in a substantially vertical orientation. Thus, the energy absorption structure 100 can be a column-like structure. The energy absorption structure 100 can have a longitudinal direction 1300, which can correspond to a longitudinal axis of the energy absorption structure 100.

Due to the configuration of the energy absorption structure 100 (e.g., arranged in a Miura-Ori pattern), it can be collapsed in the vertical direction. FIG. 14 shows the energy absorption structure 100 in the process of being compressed. FIG. 15 shows the energy absorption structure 100 in a fully compressed configuration. When the compressing force is discontinued, the energy absorption structure 100 can remain in the fully compressed configuration, or it can return to the configuration in FIG. 13.

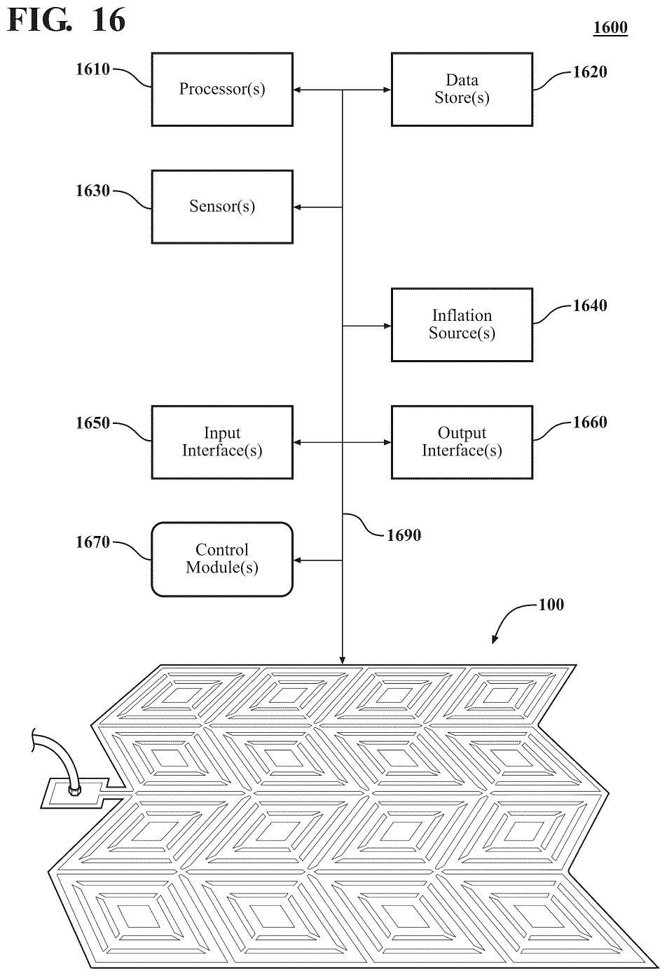

The various examples of the energy absorption structure 100 described herein can be a part of a system. Referring to FIG. 16, an example of a system 1600 for an energy absorption structure is shown. The system 1600 can include various elements. Some of the possible elements of the system 1600 are shown in FIG. 16 and will now be described. It will be understood that it is not necessary for the system 1600 to have all of the elements shown in FIG. 16 or described herein. The system 1600 can have any combination of the various elements shown in FIG. 16. Further, the system 1600 can have additional elements to those shown in FIG. 16. In some arrangements, the system 1600 may not include one or more of the elements shown in FIG. 16. Further, while the various elements may be shown as being located on or within the system 1600 in FIG. 16, it will be understood that one or more of these elements can be located external to the system 1600. Thus, such elements are not located on, within, or otherwise carried by the system 1600. Further, the elements shown may be physically separated by large distances. Indeed, one or more of the elements can be located remote from the other elements of the system 1600.

As noted above, the system 1600 can include one or more processors 1610. “Processor” means any component or group of components that are configured to execute any of the processes described herein or any form of instructions to carry out such processes or cause such processes to be performed. The processor(s) 1610 may be implemented with one or more general-purpose and/or one or more special-purpose processors. Examples of suitable processors include microprocessors, microcontrollers, DSP processors, and other circuitry that can execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The processor(s) 1610 can include at least one hardware circuit (e.g., an integrated circuit) configured to carry out instructions contained in program code. In arrangements in which there is a plurality of processors 1610, such processors can work independently from each other or one or more processors can work in combination with each other.

The system 1600 can include one or more data stores 1620 for storing one or more types of data. The data store(s) 1620 can include volatile and/or non-volatile memory. Examples of suitable data stores 1620 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 1620 can be a component of the processor(s) 1610, or the data store(s) 1620 can be operatively connected to the processor(s) 1610 for use thereby. The term “operatively connected,” as used throughout this description, can include direct or indirect connections, including connections without direct physical contact.

The system 1600 can include one or more sensors 1630. “Sensor” means any device, component and/or system that can detect, determine, assess, monitor, measure, quantify, acquire, and/or sense something. The one or more sensors can detect, determine, assess, monitor, measure, quantify, acquire, and/or sense in real-time. As used herein, the term “real-time” means a level of processing responsiveness that a user or system senses as sufficiently immediate for a particular process or determination to be made, or that enables the processor to keep up with some external process.

In arrangements in which the system 1600 includes a plurality of sensors 1630, the sensors can work independently from each other. Alternatively, two or more of the sensors can work in combination with each other. In such case, the two or more sensors can form a sensor network. The sensor(s) 1630 can be operatively connected to the processor(s) 1610, the data store(s) 1620, and/or other elements of the system 1600 (including any of the elements shown in FIG. 16).

The sensor(s) 1630 can include any suitable type of sensor. Various examples of different types of sensors will be described herein. However, it will be understood that the embodiments are not limited to the particular sensors described.

The sensor(s) 1630 can include one or more energy absorption structure sensors. The energy absorption structure sensor(s) can be configured to acquire, detect, determine, assess, monitor, measure, quantify and/or sense data or information about the body 102 itself. The body sensors can be any type of sensor, now known or later developed.

The sensor(s) 1630 can include one or more system sensors. The system sensor(s) can be configured to acquire, detect, determine, assess, monitor, measure, quantify and/or sense data or information about any system or device (or any component thereof) that the energy absorption structure 100 is a part of, such as a vehicle. The system sensor(s) can be any type of sensor, now known or later developed.

The sensor(s) 1630 can include one or more environment sensors. The environment sensor(s) can be configured to acquire, detect, determine, assess, monitor, measure, quantify and/or sense data or information about an external environment of the energy absorption structure and/or an external environment of a system or device of which the energy absorption structure 100 is a part. As an example, the environment sensor(s) can be configured to acquire, detect, determine, assess, monitor, measure, quantify and/or sense data or information about an external environment of a vehicle.

The system 1600 can include one or more inflation sources 1640. The inflation source(s) 1640 can be any source of air or other suitable gas and/or fluid, now known or later developed, for inflating the body 102. As an example, the inflation source(s) 1640 can be an air tank. The inflation source(s) 1640 can be operatively connected to the body 102 to supply a fluid to the fluid channels 130.

In some arrangements, the inflation source(s) 1640 can be operatively connected to the energy absorption structure 100 by one or more ducts, channels, conduits, tubes, hoses, and/or passages. In some arrangements, the inflation source(s) 1640 can be operatively connected to the energy absorption structure 100 by one or more fasteners, one or more clamps, and/or one or more couplings. One or more valves can be operatively positioned between the inflation source(s) 1640 and the energy absorption structure 100.

In some arrangements, the inflation source(s) 1640 can be a source of shear thickening fluid. In some arrangements, the inflation source(s) 1640 can be configured to maintain a constant fluid pressure in the fluid channels 130. In some implementations, the inflation source(s) 1640 can include a pump. In some arrangements, the inflation source(s) 1640 can include a gas canister capable of delivering a compressed gas. In some arrangements, the inflation source(s) 1640 can include a reservoir of shear thickening fluid, which can be supplied to the fluid channels to cause the inflation of the body 102.

In some arrangements, the inflation source(s) 1640 can be configured to create suction or a vacuum so as to draw the fluid in the energy absorption structure 100 back into the inflation source(s) 1640. However, in other arrangements, the suction or vacuum can be generated by some other system, device, or component. In some arrangements, the fluid drawn out of the energy absorption structure 100 can be exhausted to the environment or to some other location.

The system 1600 can include one or more input interfaces 1650. An “input interface” includes any device, component, system, element or arrangement or groups thereof that enable information/data to be entered into a machine. The input interface(s) 1650 can receive an input from a person or other entity. Any suitable input interface 1650 can be used, including, for example, a keypad, display, touch screen, multi-touch screen, button, joystick, mouse, trackball, microphone, gesture recognition (radar, lidar, camera, or ultrasound-based), and/or combinations thereof.

The system 1600 can include one or more output interfaces 1660. An “output interface” includes any device, component, system, element or arrangement or groups thereof that enable information/data to be presented to a user (e.g., a person) or other entity. The output interface(s) 1660 can present information/data to a user or other entity. The output interface(s) 1660 can include a display, an earphone, haptic device, and/or speaker. Some components of the system 1600 may serve as both a component of the input interface(s) 1650 and a component of the output interface(s) 1660. In one or more arrangements, the input interface(s) 1650 can be provided on the vehicle, or the input interface(s) 1650 can be provided remote from the vehicle, such as with a remote operator of the vehicle.

The system 1600 can include one or more modules, at least some of which will be described herein. The modules can be implemented as computer readable program code that, when executed by a processor, implement one or more of the various processes described herein. One or more of the modules can be a component of the processor(s) 1610, or one or more of the modules can be executed on and/or distributed among other processing systems to which the processor(s) 1610 is operatively connected. The modules can include instructions (e.g., program logic) executable by one or more processor(s) 1610. Alternatively or in addition, one or more data stores 1620 may contain such instructions.

The system 1600 can include one or more modules. In one or more arrangements, the modules described herein can include artificial or computational intelligence elements, e.g., neural network, fuzzy logic or other machine learning algorithms. Further, in one or more arrangements, the modules can be distributed among a plurality of modules. In one or more arrangements, two or more of the modules described herein can be combined into a single module.

The system 1600 can include one or more control modules 1670. The control module(s) 1670 can include profiles and logic for actively controlling the body 102 according to arrangements herein. The control module(s) 1670 can be configured to determine when the body 102 should be activated or deactivated. The control module(s) 1670 can be configured to do so in any suitable manner. For instance, the control module(s) 1670 can be configured to analyze data or information acquired by the sensor(s) 1630. Alternatively or additionally, the control module(s) 1670 can be configured to detect inputs (e.g., commands) provided on the input interface(s) 1650. The control module(s) 1670 can retrieve raw data from the sensor(s) 1630 and/or from the data store(s) 1620. The control module(s) 1670 can use profiles, parameters, or setting loaded into the control module(s) 1670 and/or stored in the data store(s) 1620.

The control module(s) 1670 can analyze the sensor data to determine an appropriate action for the body 102. For instance, the control module(s) 1670 can detect changes to the body 102 and/or forces affecting the body 102. The control module(s) 1670 can be configured to determine appropriate changes to the shape, configuration, and/or morphology of the body 102 based on real-time conditions. The control module(s) 1670 can be configured to cause the body 102 to be activated or deactivated. As used herein, “cause” or “causing” means to make, force, compel, direct, command, instruct, and/or enable an event or action to occur or at least be in a state where such event or action may occur, either in a direct or indirect manner. For instance, the control module(s) 1670 can selectively permit or prevent the flow of air or fluid from the inflation source(s) 1640 to the energy absorption structure 100. The control module(s) 1670 can be configured send control signals or commands over a communication network to the inflation source(s) 1640 or other element of the system 1600.

The control module(s) 1670 can be configured to cause the energy absorption structure 100 to be selectively activated or deactivated based on one or more activation parameters. For instance, the control module(s) 1670 can be configured to compare sensor data to one or more activation thresholds. If the threshold is met, then the control module(s) 1670 can cause the energy absorption structure 100 to be inflated or maintained in an inflated condition. If the threshold is not met, then the control module(s) 1670 can cause the energy absorption structure 100 to be deflated or maintained in a deflated or non-activated state. In some instances, the control module(s) 1670 can be configured to cause the body 102 to be selectively inflated or deflated based on user inputs (e.g., commands or other inputs indicative of inflating or deflating the body 102) For instance, a user can provide an input on the input interface(s) 1650.

In some instances, the control module(s) 1670 can be configured to cause the energy absorption structure 100 to be selectively inflated or deflated based on a current operational state of a structure (e.g., a vehicle) with which the energy absorption structure 100 is associated or an environment in which the energy absorption structure 100 is located. For instance, when the energy absorption structure 100 is used in connection with a vehicle, the control module(s) 1670 can be configured to cause the energy absorption structure 100 to be selectively activated when a crash is occurring or is predicted. The operational state of the vehicle may be determined based on sensor data and/or user inputs.

The various elements of the system 1600 can be communicatively linked to one another or one or more other elements through one or more communication networks 1690. As used herein, the term “communicatively linked” can include direct or indirect connections through a communication channel, bus, pathway or another component or system. A “communication network” means one or more components designed to transmit and/or receive information from one source to another. The data store(s) 1620 and/or one or more other elements of the system 1600 can include and/or execute suitable communication software, which enables the various elements to communicate with each other through the communication network and perform the functions disclosed herein.

The one or more communication networks can be implemented as, or include, without limitation, a wide area network (WAN), a local area network (LAN), the Public Switched Telephone Network (PSTN), a wireless network, a mobile network, a Virtual Private Network (VPN), the Internet, a hardwired communication bus, and/or one or more intranets. The communication network further can be implemented as or include one or more wireless networks, whether short range (e.g., a local wireless network built using a Bluetooth or one of the IEEE 802 wireless communication protocols, e.g., 802.11a/b/g/i, 802.15, 802.16, 802.20, Wi-Fi Protected Access (WPA), or WPA2) or long range (e.g., a mobile, cellular, and/or satellite-based wireless network; GSM, TDMA, CDMA, WCDMA networks or the like). The communication network can include wired communication links and/or wireless communication links. The communication network can include any combination of the above networks and/or other types of networks.

Now that the various potential systems, devices, elements and/or components of the system 1600 have been described, various methods will now be described. Various possible steps of such methods will now be described. The methods described may be applicable to the arrangements described above, but it is understood that the methods can be carried out with other suitable systems and arrangements. Moreover, the methods may include other steps that are not shown here, and in fact, the methods are not limited to including every step shown. The blocks that are illustrated here as part of the methods are not limited to the particular chronological order. Indeed, some of the blocks may be performed in a different order than what is shown and/or at least some of the blocks shown can occur simultaneously.

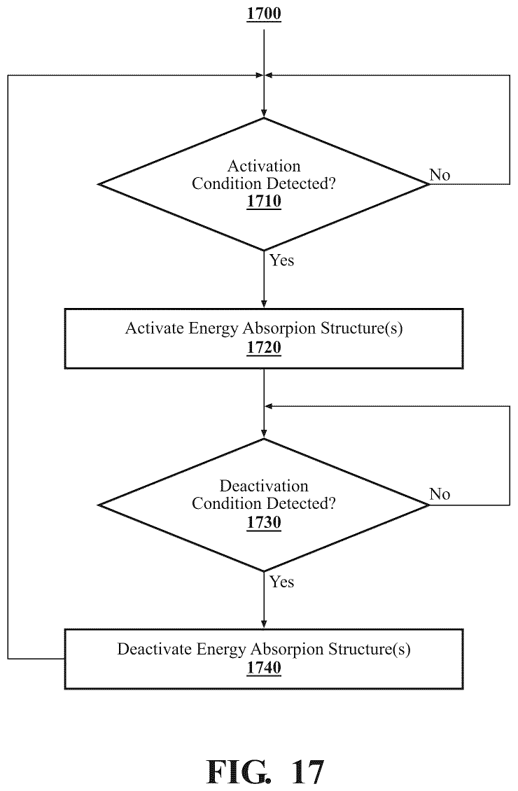

Turning to FIG. 17, an example of a method 1700 is shown. For the sake of discussion, the method 1700 can begin with the energy absorption structure 100 in a non-activated mode. In the non-activated mode, the energy absorption structure can be non-inflated. The body 102 can be in a non-activated configuration, such as is shown in FIGS. 1, 3, 6, 9, and 11.

At block 1710, it can be determined whether an activation condition has been detected. The activation condition may be detected by the control module(s) 1670, the processor(s) 1610, and/or one or more sensor(s) 1630. For instance, the control module(s) 1670, the processor(s) 1610, and/or one or more sensor(s) 1630 can determine that data acquired by the sensor(s) 1630 meets an activation condition. For instance, the control module(s) 1670, the processor(s) 1610, and/or one or more sensor(s) 1630 can determine whether the sensor data acquired by the sensor(s) 1630 (e.g., data/information about the body 102 and/or the environment of the body 102, etc.) meets an activation threshold. Alternatively or in addition, the control module(s) 1670, the processor(s) 1610, and/or one or more sensor(s) 1630 can detect a user input indicating that the body 102 should be activated. The user input can be provided via the input interface(s) 1650.

If an activation condition is not detected, the method 1700 can end, return to block 1710, or proceed to some other block. However, if an activation condition is detected, then the method can proceed to block 1720. At block 1720, the energy absorption structure 100 can be activated. Thus, the control module(s) 1670 and/or the processor(s) 1610 can cause or allow air or other fluid to be supplied from the inflation source(s) 1640 to the energy absorption structure 100.

As a result, the energy absorption structure 100 can morph in an active configuration. Examples of the activated configurations are shown in FIGS. 2, 4, 5, 7, 8, 10, 12, and 13. The method can continue to block 1730.

At block 1730, it can be determined whether a deactivation condition has been detected. The body deactivation condition may be detected by the control module(s) 1670, such as based on data acquired by the sensor(s) 1630 and/or by detecting a user input or the cessation of a user input. If a seat deactivation condition is not detected, the method 1700 can return to block 1730, or proceed to some other block. However, if a deactivation condition is detected, then the method can proceed to block 1740. At block 1740, the energy absorption structure 100 can be deactivated or deflated. Thus, the control module(s) 1670 and/or the processor(s) 1610 can cause the supply of fluid to the energy absorption structure 100 to be discontinued. In some arrangements, the control module(s) 1670 and the processor(s) 1610 can cause a vacuum to be created to draw the fluid out of the energy absorption structure 100. Such fluid can be expelled or drawn back into the inflation source(s) 1640. As a result, the energy absorption structure 100 can substantially return to a non-activated configurations.

The method 1700 can end. Alternatively, the method 1700 can return to block 1710 or some other block. The method 1700 can be repeated at any suitable point, such as at a suitable time or upon the occurrence of any suitable event or condition.

Arrangements described herein can be used in various applications. For example, arrangements described herein can be used in connection with any application in which energy absorption is desired. In one or more arrangements, arrangements described herein can be used in connection with a vehicle. The term “vehicle” means any form of transport, now known or later developed. The vehicle can be a form of motorized transport. Non-limiting examples of vehicles include automobiles, motorcycles, aerocars, or any other form of motorized transport. While arrangements herein will be described in connection with land-based vehicles, it will be appreciated that arrangements are not limited to land-based vehicles. Indeed, in some arrangements, the vehicle can be water-based, air-based, or space-based vehicles. Of course, arrangements described herein can be used in various non-vehicular applications.

It will be appreciated that arrangements described herein can provide numerous benefits, including one or more of the benefits mentioned herein. For example, arrangements described herein can achieve an inflatable structure that is lightweight. Arrangements described herein can achieve such a structure at potentially low cost. Arrangements described herein can provide an inflatable structure that is stowable to a flat configuration and deployable to a rigid state. Arrangements described herein can enable tailorable energy absorption properties as a function of fluid pressure/properties. Arrangements described herein can provide a structure that can collapse in a predetermined way such that its energy absorption capability will be improved. Arrangements described herein can enable a structure to be stowed flat when not in use for energy absorption purposes, making its use suitable for space-saving design applications. Arrangements described herein can provide a structure that can be reused after each operation cycle (stow-deploy-absorb energy). Arrangements described herein can enable a structure to be filled with different fluids to enhance its energy absorption properties. Arrangements described herein can produce Miura-Ori folding when positive pressure applied to the internal channels.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “or” is intended to mean an inclusive “or” rather than an exclusive “or.” The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g., AB, AC, BC or ABC). As used herein, the term “substantially” or “about” includes exactly the term it modifies and slight variations therefrom. Thus, the term “substantially parallel” means exactly parallel and slight variations therefrom. “Slight variations therefrom” can include within 15 degrees/percent/units or less, within 14 degrees/percent/units or less, within 13 degrees/percent/units or less, within 12 degrees/percent/units or less, within 11 degrees/percent/units or less, within 10 degrees/percent/units or less, within 9 degrees/percent/units or less, within 8 degrees/percent/units or less, within 7 degrees/percent/units or less, within 6 degrees/percent/units or less, within 5 degrees/percent/units or less, within 4 degrees/percent/units or less, within 3 degrees/percent/units or less, within 2 degrees/percent/units or less, or within 1 degree/percent/unit or less. In some instances, “substantially” can include being within normal manufacturing tolerances.

Aspects herein can be embodied in other forms without departing from the spirit or essential attributes thereof. Accordingly, reference should be made to the following claims, rather than to the foregoing specification, as indicating the scope hereof.

What is claimed is:

1. An energy absorption structure comprising:
an inflatable body including a plurality of cells arranged in a Miura-Ori pattern, each of the plurality of cells including one or more fluid channels.

2. The energy absorption structure of claim 1, wherein the inflatable body includes:
a first layer;
a second layer; and
an intermediate layer located between the first layer and the second layer, the intermediate layer including a plurality of structures that, when operatively connected to the first layer and the second layer define the one or more fluid channels of the plurality of cells.

3. The energy absorption structure of claim 1, further including an inlet in fluid communication with the one or more fluid channels of the plurality of cells.

4. The energy absorption structure of claim 1, wherein the one or more fluid channels of the plurality of cells are fluidly connected.

5. The energy absorption structure of claim 1, further including a shear thickening fluid provided in one or more portions of a portions of at least one of the fluid channels.

6. The energy absorption structure of claim 1, wherein, in a non-activated configuration, the inflatable body is substantially flat, and wherein, in an activated configuration, the inflatable body deforms in a plurality of directions.

7. The energy absorption structure of claim 1, wherein, in one or more of the plurality of cells, the one or more fluid channels are arranged in a substantially concentric pattern.

8. The energy absorption structure of claim 1, wherein the plurality of cells are a parallelogram shape.

9. The energy absorption structure of claim 8, wherein the plurality of cells are a non-rectangular parallelogram shape.

10. The energy absorption structure of claim 8, wherein the inflatable body has a first side and a second side opposite the first side, and wherein the first side and the second side are operatively connected to each other such that the inflatable body is substantially tubular.

11. The energy absorption structure of claim 10, wherein the first side and the second side have a zigzag shape, wherein the first side and the second side are configured to substantially matingly engage each other.

12. The energy absorption structure of claim 11, wherein the inflatable body is collapsable in a longitudinal direction.

13. A system comprising:
an energy absorption structure having an inflatable body including a plurality of cells arranged in a Miura-Ori pattern, each of the plurality of cells including one or more fluid channels; and
one or more processors operatively connected to cause the energy absorption structure to be inflated.

14. The system of claim 13, further including one or more inflation sources operatively connected to inflate the inflatable body, and wherein the one or more processors are operatively connected to control a supply of fluid from the one or more inflation sources to the inflatable body.

15. The system of claim 14, wherein the one or more processors are programmed to initiate executable operations comprising:
detecting an activation condition; and
responsive to detecting the activation condition, causing a fluid to be supplied to the inflatable body, whereby the inflatable body inflates into an activated configuration.

16. The system of claim 15, wherein, in an activated configuration, the inflatable body deforms in a plurality of directions.

17. The system of claim 15, further including one or more sensors operatively connected to the one or more processors, wherein the one or more sensors are configured to acquire sensor data, and wherein detecting the activation condition is based on sensor data acquired by the one or more sensors.

18. The system of claim 15, further including an input interface operatively connected to the one or more processors, and wherein detecting the activation condition is based on a user input on the input interface.

19. The system of claim 15, wherein the executable operations further include:
detecting a deactivation condition; and
responsive to detecting the deactivation condition, causing the inflatable body to be deflated, whereby the inflatable body substantially returns to a non-activated configuration.

20. The system of claim 13, wherein the one or more fluid channels of the plurality of cells are fluidly connected.

21. The system of claim 13, further including a shear thickening fluid provided in one or more portions of a portions of at least one of the fluid channels.

22. The system of claim 13, wherein, in one or more of the plurality of cells, the one or more fluid channels are arranged in a substantially concentric pattern.

23. The system of claim 13, wherein the inflatable body has a first side and a second side opposite the first side, and wherein the first side and the second side are operatively connected to each other such that the inflatable body is substantially tubular.
